(19) United States
(12) Patent Application Publication
(10) Pub. No.: US 2011/0316893 A1
(43) Pub. Date: Dec. 29, 2011

(54) ORGANIC LIGHT EMITTING DISPLAY DEVICE AND DRIVING METHOD FOR THE SAME

(75) Inventors: Duk-Jin Lee, Yongin-city (KR); Soon-Ryong Park, Yongin-city (KR); Woo-Suk Jung, Yongin-city (KR)

(73) Assignee: Samsung Mobile Display Co., Ltd., Yongin-city (KR)

(21) Appl. No.: 13/095,718

(22) Filed: Apr. 27, 2011

(30) Foreign Application Priority Data
Jun. 25, 2010 (KR) 10-2010-0060650

(51) Int. Cl. G09G 3/30; G09G 5/10

(52) U.S. Cl. 345/690; 345/77

(57) ABSTRACT

An organic light emitting display device is disclosed. The display device has improved yield because luminance of the manufactured display devices can be adjusted so as to meet the manufacturing specification. The display device includes a gamma measurer configured to measure a gamma value by comparing the amount of current with a luminance of the pixel unit, a voltage estimator configured to calculate a voltage of the first power supply based on a difference in a desired gamma value and a gamma value measured by the gamma measurer, and a DC-DC converter configured to generate voltages for the first and second power supplies, wherein the voltage of at least the first power supply is based on the voltage calculated by the voltage estimator.

### CROSS-REFERENCE TO RELATED APPLICATIONS

This application claims priority to and the benefit of Korean Patent Application No. 10-2010-0060650, filed on Jun. 25, 2010, in the Korean Intellectual Property Office, the entire content of which is incorporated herein by reference.

### BACKGROUND

1. Field

The disclosed technology relates to an organic light emitting display device and a driving method for the display, and more particularly to an organic light emitting display device that has fewer visual artifacts caused by changes in gamma characteristics which occur because of process variation, and a driving method for the organic light emitting display device.

2. Description of the Related Technology

Recently, a variety of flat panel displays having less weight and volume than cathode ray tubes, have been developed. Typical flat panel displays include liquid crystal displays, field emission displays, plasma display panels, and organic light emitting display devices.

An organic light emitting display device displays an image, using organic light emitting diodes that produces light by recombining electrons and holes which is generated by current flow.

The application field of the organic light emitting display devices includes PDAs, MP3 players, and mobile phones because of their advantages, such as high color reproduction and thin profiles.

FIG. 1 is a circuit diagram illustrating a pixel of a common organic light emitting display device. Referring to FIG. 1, a pixel is connected with a data line Dm and a scan line Sn and includes a first transistor M1, a second transistor M2, a capacitor Cst, and an organic light emitting diode OLED.

The first transistor M1 has a source connected to a first power supply ELVDD, a drain connected to the anode electrode of the organic light emitting diode OLED, and a gate connected to a first node N1. The second transistor M2 has a source connected to the data line Dm, a drain connected to the first node N1, and a gate connected to the scan line Sn. The capacitor Cst has a first electrode connected to the first power supply ELVDD and a second electrode connected to the first node N1. Further, the organic light emitting diode OLED has the anode electrode connected to the drain of the first transistor M1 and a cathode electrode connected to a second power supply ELVSS.

In the pixel having this configuration, voltage of the first node N1 depends on a data signal transmitted through the data line Dm, and the first transistor M1 allows current to flow from the first power supply ELVDD to the second power supply ELVSS in accordance with voltage of the first node N1. The organic light emitting diode OLED emits light based on the current provided by the first transistor M1 in response to the data signal and the voltage of the first power supply ELVDD.

In addition, an organic light emitting display device is manufactured by depositing many pixels on a substrate. The luminance is somewhat different in each of the organic light emitting display devices due to process variation generated in manufacturing the display devices. When a display has luminance outside an acceptable tolerance the display is considered defective.

The yield is reduced by the organic light emitting display devices with unacceptable luminance. It is preferable to improve the yield by adjusting the luminance of the defective organic light emitting devices to be within acceptable tolerance limits.

### SUMMARY OF CERTAIN INVENTIVE ASPECTS

One inventive aspect is an organic light emitting display device. The display device includes a pixel unit with a plurality of pixels, each configured to emit light having a luminance based on an amount of current flowing therethrough from a first power supply to a second power supply. The display device also includes a gamma measurer configured to measure a gamma value by comparing the amount of current with a luminance of the pixel unit, a voltage estimator configured to calculate a voltage of the first power supply based on a difference in a desired gamma value and a gamma value measured by the gamma measurer, and a DC-DC converter configured to generate voltages for the first and second power supplies, where the voltage of at least the first power supply is based on the voltage calculated by the voltage estimator.

Another inventive aspect is a method of operating an organic light emitting display device. The method includes determining a gamma characteristic value by determining an amount of current flowing from a first power supply to a second power supply and a luminance of the display device corresponding to the amount of current, comparing the gamma characteristic value with a desired gamma characteristic value, and adjusting the voltage of the first power supply based on the comparison.

### BRIEF DESCRIPTION OF THE DRAWINGS

The accompanying drawings, together with the specification, illustrate exemplary embodiments, and, together with the description, serve to explain various inventive principles and aspects.

FIG. 1 is a circuit diagram illustrating a pixel of an organic light emitting display device;

FIG. 2 is a block diagram illustrating the structure of an organic light emitting display device according to some embodiments;

FIG. 3 is a circuit diagram illustrating a DC-DC converter of the organic light emitting display device shown in FIG. 2;

FIG. 4 is a block diagram showing the structure of a voltage estimator of the organic light emitting display device show in FIG. 2; and

FIG. 5 is a block diagram showing the structure of a gamma correction circuit of the organic light emitting display device show in FIG. 2.

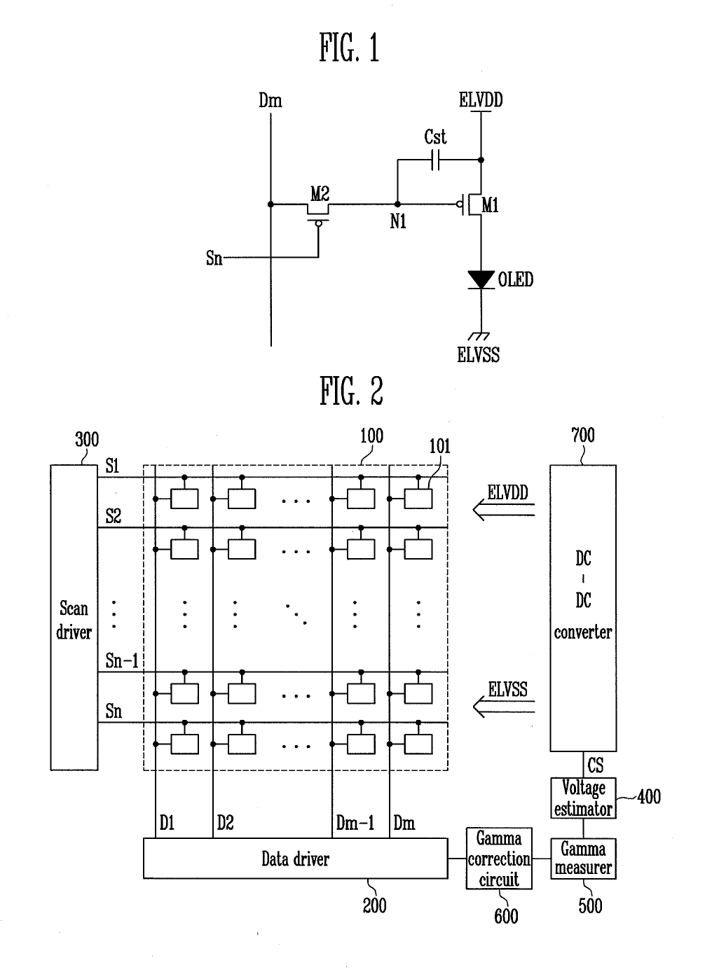

### DETAILED DESCRIPTION OF CERTAIN INVENTIVE EMBODIMENTS

Hereinafter, certain exemplary embodiments are described with reference to the accompanying drawings. When a first element is described as being coupled to a second element, the first element may be directly coupled to the second element or may be indirectly coupled to the second element via a third element. Further, some of the elements that are not essential to the complete understanding of the invention are omitted for clarity. Also, like reference numerals generally refer to like elements throughout.

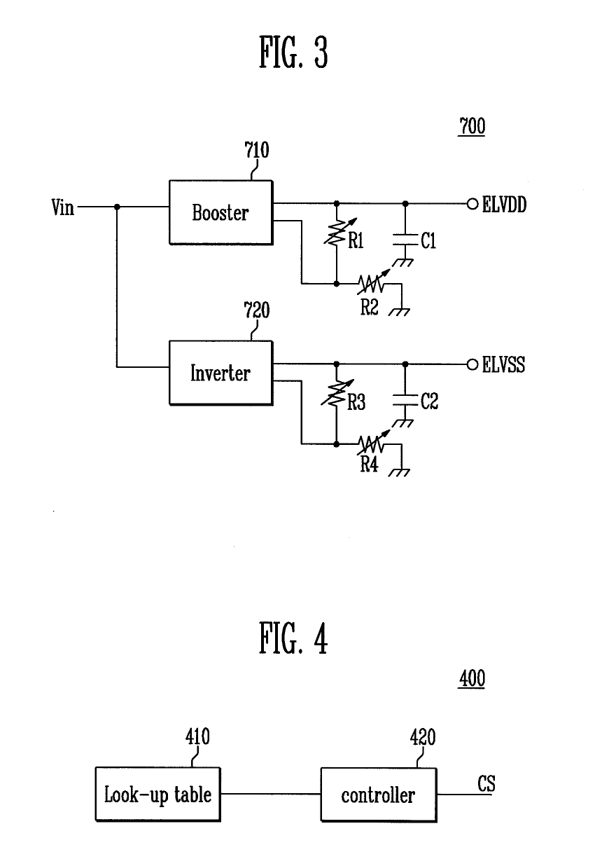

FIG. 2 is a block diagram illustrating the structure of an organic light emitting display device according to some embodiments. Referring to FIG. 2, an organic light emitting display device includes a pixel unit 100, a data driver 200, a scan driver 300, a voltage estimator 400, a gamma measurer 500, a gamma correction circuit 600, and a DC-DC converter 700.

The pixel unit 100 has a plurality of pixels 101, in which a plurality of data lines D1, D2 . . . Dm−1, Dm for transmitting data signals to the pixels 101 and a plurality of scan lines S1, S2 . . . Sn−1, Sn for transmitting a plurality of scan signals to the pixels 101. Further, a first pixel power line (not shown) and a second pixel power line (not shown) that transmit first pixel power ELVDD and second power ELVSS for driving the pixels 101 are formed. In some embodiments, the second pixel power line is formed not as a line, but instead as a layer covering substantially the entire pixel unit 100.

The data driver 200 generates data signals and transmits the data signal to the data lines D1, D2 . . . Dm−1, Dm.

The scan driver 300 generates scan signals and transmits the scan signals to the scan lines S1, S2 . . . Sn−1, Sn. The data signals are transmitted to the pixels 101 where the scan signals have been transmitted.

The voltage estimator 400 calculates optimum first power ELVDD and/or second power ELVSS from a difference between a measured gamma characteristic value and a desired gamma characteristic value. Further, the voltage estimator 400 controls the voltage output from the DC-DC converter 700 by outputting a control signal CS to the DC-DC converter 700.

The gamma measurer 500 determines the amount of current flowing in the pixel unit 100 and luminance of the pixel unit 100, and also determines a gamma characteristic value according to the determined amount of current and luminance of the pixel unit 100.

The gamma correction circuit 600 generates gradation voltage according to the gamma characteristic value by storing the desired gamma characteristic value in a register.

The DC-DC converter 700 generates the first pixel power ELVDD and the second pixel power ELVSS. In generating the first and second pixel powers, the DC-DC converter 700 outputs substantially the voltage of the first power supply ELVDD and/or the second voltage ELVSS according to the calculations of the voltage estimator 400.

FIG. 3 is a circuit diagram illustrating an embodiment of a DC-DC converter 700 of the organic light emitting display device shown in FIG. 2. Referring to FIG. 3, the DC-DC converter 700 includes a booster 710 and an inverter 720.

The booster 710 generates the first power ELVDD by boosting input voltage Vin. A first resistor R1 and a second resistor R2 are connected to the output terminal of the booster 710 and the first resistor R1 and the second resistor R2 are variable resistors of which the resistance is adjusted. Further, the voltage of the first power ELVDD is adjusted based on the resistance values of the first and second resistors R1 and R2.

The inverter 720 generates the second power ELVSS by inverting the input voltage Vin. A third resistor R3 and a fourth resistor R4 are connected to the output terminal of the inverter 720 and the third resistor R3 and the fourth resistor R4 are variable resistors of which the resistance is adjusted. Further, the voltage of the second power ELVSS is adjusted based on the resistance values of the third and fourth resistors R3 and R4.

Further, a first capacitor C1 and a second capacitor C2 are connected to the output terminals of the booster 710 and the inverter 720, respectively, to maintain the voltage of the output terminals.

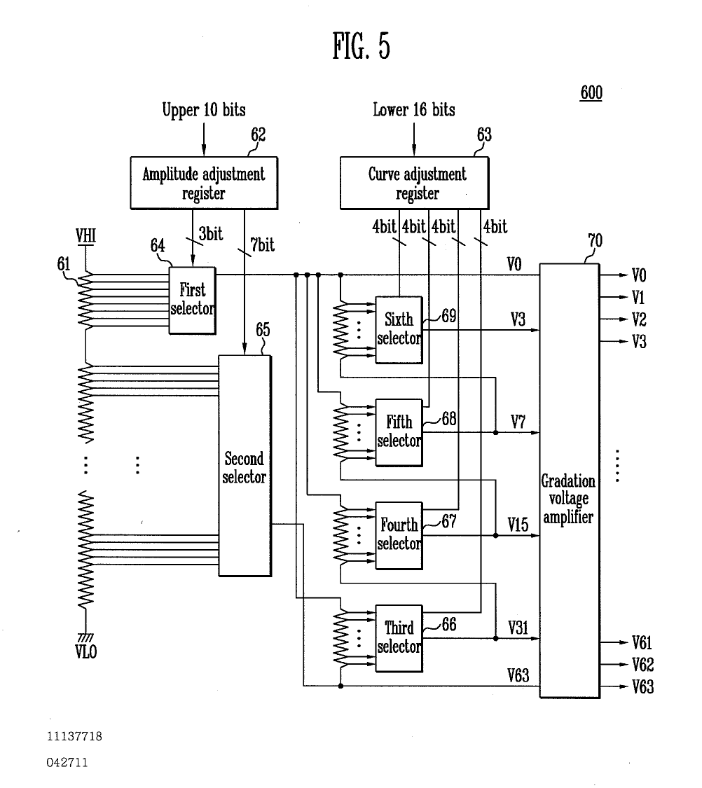

FIG. 4 is a diagram showing the structure of an embodiment of a voltage estimator 400 of the organic light emitting display device show in FIG. 2. Referring to FIG. 4, the voltage estimator 400 includes a look-up table 410 and a controller 420.

The look-up table 410 stores voltage values for the first power supply and/or the second power supply, based on a difference between the measured gamma characteristic and the desired gamma characteristic. Therefore, the voltage of the first power supply ELVDD and/or the second power supply ELVSS is determined from the difference between the gamma characteristic value measured by the gamma measurer 500 and the desired gamma characteristic value. The voltage values of the first power supply ELVDD and/or the second power supply ELVSS which are stored in the look-up table 410 can be, for example, determined by experiment and may be different in accordance with the size of the pixel unit 100.

The controller 420 outputs a signal corresponding to the voltage value for the first power supply ELVDD and/or the second power supply ELVSS which is stored in the look-up table 410 such that the actual voltage of the first power supply ELVDD and/or the second power supply ELVSS which is outputted from the DC-DC converter 700 can be adjusted.

The amount of current flowing in the pixels corresponds to the voltage of the first power supply ELVDD and the data signal; therefore, the amount of current flowing in the pixels is adjusted by adjusting the voltage of the first power supply ELVDD. A consequence of the adjusted first power supply ELVDD is that the luminance of the pixel unit 100 changes. Therefore, when luminance is lower than a desired level, the voltage of the first power supply ELVDD is adjusted so that the amount of current flowing in the pixels increases, and when the luminance is higher than the desired level, the voltage of the first power supply ELVDD is adjusted so that the amount of current flowing in the pixels decreases. Accordingly, the number of defective products may be reduced by achieving luminance of the pixel unit 100 at the desired level.

FIG. 5 is a diagram showing the structure of an embodiment of a gamma correction circuit 600 of the organic light emitting display device show in FIG. 2. Referring to FIG. 5, the gamma correction circuit includes a resistor ladder 61, an amplitude adjustment resistor 62, a curve adjustment resistor 63, first through sixth selectors 64 to 69, and a gradation voltage amplifier 70.

The resistor ladder 61 has reference voltage that is the highest voltage VHI supplied from the outside, comprises a plurality of variable resistors that are connected in series between the lowest voltage VLO and the reference voltage, and generates a plurality of gradation voltages. Further, when the resistance of the resistor ladder 61 decreases, the amplitude adjustment range decreases, and accuracy of the adjustment is improved. On the contrary, when the resistance of the ladder resistor 61 increases, the amplitude adjustment range increases, and accuracy of the adjustment decreases.

The amplitude adjustment register 62 outputs a 3-bit resistor set value to the first selector 64 and a 7-bit set value to the second selector 65. It is possible to increase selectable number of gradations by increasing the number of bits and it is also possible to change gradation voltages by changing the resistor set value.

The curve adjustment register 63 outputs a 4-bit resistor set value to the third through sixth selectors 66-69. The resistor set value can be changed and it is possible to adjust selectable gradation voltages in accordance with the resistor set value.

In this embodiment, the upper 10 bits in the resistor values generated by the gamma measurer 500 is input to the amplitude adjustment register 62 and the lower 16 bits are input to the curve adjustment register 63, and they are selected as resistor set values.

The first selector 64 selects a voltage corresponding to the 3-bit resistor set value set by the amplitude adjustment register 62 from the voltages generated by the resistor ladder 61 and outputs the selected voltage as the highest gradation voltage.

The second selector 65 selects a voltage corresponding to the 7-bit resistor set value set by the amplitude adjustment register 62 from the voltages generated by the resistor ladder 61 and outputs the selected voltage as the lowest gradation voltage.

The third selector 66 selects a voltage between the voltage output from the first selector 64 and the voltage output from the second selector 65, and outputs the selected voltage corresponding to the 4-bit resistor set value applied thereto.

The fourth selector 67 selects a voltage between the voltage output from the first selector 64 and the voltage output from the third selector 66, and outputs the selected voltage corresponding to the 4-bit resistor set value.

The fifth selector 68 selects and outputs a voltage between the voltage output by the first selector 64 and the voltage output by the fourth selector 67 according to the 4-bit resistor set value applied thereto.

The sixth selector 69 selects and outputs a voltage between the voltage output by the first selector 64 and the voltage output by the fifth selector 68 according to the 4-bit resistor set value applied thereto.

The curve of a halftone portion as determined by the resistor set value of the curve adjustment register 63 results in efficient control of the gamma characteristic in accordance with the characteristic of each light emitting device. Further, the voltage difference between data values is large at lower data values in order to make the gamma curve convex downward, whereas the resistance of the resistors of resistor ladder 61 is set such that the voltage difference for the different data values is lower at lower data values in order to make the gamma curve characteristic convex upward.

The gradation voltage amplifier 70 outputs a plurality of voltages corresponding to the data values that are displayed on the pixel unit 100. FIG. 5 shows output of voltages corresponding to 64-bit gradation.

In the embodiments described above, it is possible to set the amplitude and the curve through the curve adjustment register 63 and the amplitude adjustment register 62 for each of R, G, and B by installing the gamma correction circuit for each R, G, B group such that the R, G, and B acquire the same luminance, in consideration of different characteristics of the R, G, B light emitting device themselves.

While the various features and aspects have been described in connection with certain exemplary embodiments, it is to be understood that the invention is not limited to the disclosed embodiments, but, on the contrary, is intended to cover various modifications and equivalent arrangements.

What is claimed is:

1. An organic light emitting display device, comprising:
a pixel unit including a plurality of pixels, each configured to emit light having a luminance based on an amount of current flowing therethrough from a first power supply to a second power supply;
a gamma measurer configured to measure a gamma value by comparing the amount of current with a luminance of the pixel unit;
a voltage estimator configured to calculate a voltage of the first power supply based on a difference in a desired gamma value and a gamma value measured by the gamma measurer; and
a DC-DC converter configured to generate voltages for the first and second power supplies, wherein the voltage of at least the first power supply is based on the voltage calculated by the voltage estimator.

2. The organic light emitting display device as claimed in claim 1, wherein the voltage estimator includes a look-up table storing voltages of the first power supply which correspond to differences between desired gamma values and measured gamma values.

3. The organic light emitting display device as claimed in claim 2, wherein the DC-DC converter has a resistor connected to an output terminal of the first power supply and the voltage of the first power supply is changed by adjusting resistance of the resistor.

4. The organic light emitting display device as claimed in claim 3, wherein the voltage estimator further includes a controller that adjusts the resistance of the resistor.

5. The organic light emitting display device as claimed in claim 1, wherein the DC-DC converter includes:
a booster that outputs the voltage of the first power supply; and
an inverter that outputs the voltage of the second power supply.

6. The organic light emitting display device as claimed in claim 1, wherein the voltage estimator calculates the voltage of the second power supply.

7. The organic light emitting display device as claimed in claim 6, wherein the DC the voltage of second power supply is based on the voltage calculated by the voltage estimator.

8. The organic light emitting display device as claimed in claim 7, wherein the voltage estimator includes a look-up table storing voltages of the second power supply which correspond to differences between desired gamma values and measured gamma values.

9. The organic light emitting display device as claimed in claim 8, wherein the DC-DC converter has a resistor connected to an output terminal of the second power supply and the voltage of the second power supply is changed by adjusting resistance of the resistor.

10. The organic light emitting display device as claimed in claim 1, further comprising a gamma correction unit, configured to generate gamma corrected reference voltages based on the voltages of the first and second power supplies.

11. The organic light emitting display device as claimed in claim 10, wherein the gamma correction unit comprises first and second voltage selectors configured to determine highest and lowest reference voltages, respectively, wherein the selection of the highest and lowest reference values is based on resistor values determined by the gamma measurer.

12. The organic light emitting display device as claimed in claim 11, wherein the gamma correction unit further comprises one or more additional voltage selectors configured to determine one or more additional reference voltages, respectively, wherein the additional references are between the highest and lowest reference voltages, and wherein the selection of the additional reference values is based on one or more additional resistor values determined by the gamma measurer.

13. A method of operating an organic light emitting display device, the method comprising:
determining a gamma characteristic value by determining an amount of current flowing from a first power supply to a second power supply and a luminance of the display device corresponding to the amount of current;
comparing the gamma characteristic value with a desired gamma characteristic value; and
adjusting the voltage of the first power supply based on the comparison.

14. The method of operating an organic light emitting display device as claimed in claim 13, further comprising adjusting the voltage of the second power supply based on the comparison.

15. The method of operating an organic light emitting display device as claimed in claim 14, wherein the voltage of the second power supply is adjusted by adjusting a resistance of a resistor connected to an output from which the voltage of second power supply is output.

16. The method of operating an organic light emitting display device as claimed in claim 14, wherein the voltage value of the second power supply is stored in a look-up table.

17. The method of operating an organic light emitting display device as claimed in claim 13, wherein the voltage of the first power supply is adjusted by adjusting the resistance of a resistor connected to an output from which the voltage of first power supply is output.

18. The method of operating an organic light emitting display device as claimed in claim 13, wherein the voltage value of the first power supply is stored in a look-up table.

19. The method of operating an organic light emitting display device as claimed in claim 13, further comprising generating gamma corrected reference voltages based on the voltages of the first and second power supplies.

20. The method of operating an organic light emitting display device as claimed in claim 13, further comprising determining highest and lowest reference voltages, respectively with first and second voltage selectors, wherein the selection of the highest and lowest reference values is based on resistor values determined by the gamma measurer.
